(19) United States
(12) Patent Application Publication
(10) Pub. No.: US 2014/0338544 A1
(43) Pub. Date: Nov. 20, 2014

(54) COOKING ASSEMBLY

(71) Applicant: Tsann Kuen Zhangzhou, Fujian (CN)

(72) Inventor: Chunyu Wu, Fujian (CN)

(73) Assignee: Tsann Kuen Zhangzhou, Fujian (CN)

(21) Appl. No.: 14/278,671

(22) Filed: May 15, 2014

(30) Foreign Application Priority Data
May 20, 2013 (CN) 201320275626.4

(51) Int. Cl. A47J 37/06; A47J 27/62

(52) U.S. Cl. CPC A47J 37/0676; A47J 27/62
USPC 99/331; 219/450.1

(57) ABSTRACT

A cooking assembly comprises: a cooking base unit having a cooking surface that is adapted to be heated by a heater; an upper platen unit pivoted to the cooking base unit; a heater controller connected to the cooking base unit, adapted to be connected to the heater, and configured to generate output signals corresponding respectively to different cooking modes for controlling the heater; a contact module secured to the cooking base unit and defining contact regions that are disposed along a contact path; and a conductive contact member connected to and driven by the upper platen unit to move along the contact path when the upper platen unit rotates relative to the cooking base unit so as to contact a selected one of the contact regions.

### CROSS-REFERENCE TO RELATED APPLICATION

This application claims priority of Chinese Application No. 201320275626.4, filed on May 20, 2013.

### BACKGROUND OF THE INVENTION

1. Field of the Invention

This invention relates to a cooking assembly, more particularly to a cooking assembly including a heater controller that can generate different output signals for controlling a heater in response to different positions of an upper platen unit, relative to a cooking base unit.

2. Description of the Related Art

A conventional cooking assembly, such as a griddle or a grill, normally includes a cooking base with a heating surface for supporting and cooking food thereon, a heater for heating the heating surface, an upper platen that cooperates with the cooking base to cook food on the heating surface, and a heater controller for controlling the heater. The conventional cooking assembly may further include a temperature sensor and a control panel having buttons for different cooking modes. The temperature sensor and the control panel are electrically connected to the heater controller so that the heater controller may generate output signals corresponding to the cooking modes for the heater to cook different food. In operation, a user can press one of the buttons on the control panel to select one of the cooking modes based on the food to be cooked and the experience of the user.

### SUMMARY OF THE INVENTION

The object of the present invention is to provide a cooking assembly including a heater controller that can generate different output signals tor a heater in response to different positions of an upper platen unit that correspond to different thicknesses of the food to be cooked, respectively.

According to this invention, there is provided a cooking assembly that comprises; a cooking base unit having a cooking surface that is adapted to be heated by a heater; an upper platen unit pivoted to the cooking base unit; a heater controller connected to the cooking base unit, adapted to be connected to the heater, and configured to generate output signals corresponding respectively to different cooking modes for controlling the heater; a contact module secured to the cooking base unit and defining a plurality of conductive contact regions that are electrically connected to the heater controller and that are operatively associated with said heater controller for the generation of said output signals, the contact regions being disposed along a contact path; and a conductive contact member connected to and driven by the upper platen unit to move along the contact path when the upper platen unit rotates relative to the cooking base unit so as to contact a selected one of the contact regions to enable the heater controller to generate a corresponding one of the output signals.

### BRIEF DESCRIPTION OF THE DRAWINGS

In drawings which illustrate an embodiment of the invention.

FIG. 1 is a perspective view of the preferred embodiment of a cooking assembly according to the present invention, illustrating a state where an upper platen unit is in contact with a cooking surface of a cooking base unit;

FIG. 2 is another perspective view of the preferred embodiment to illustrate another state where the upper platen unit is spaced apart from the cooking surface by a food body;

FIG. 3 is a fragmentary partly exploded perspective view of a handle, a transmission unit, a contact module and a movable contact unit of the preferred, embodiment;

FIG. 4 is a perspective partly cutaway view to illustrate how the movable contact unit is connected to the contact module of the preferred embodiment;

FIG. 5 is a fragmentary sectional view illustrating the state of FIG. 1 in which a first contact member of the movable contact unit does not contact any one of first conductors of the contact module;

FIG. 6 is a schematic side view illustrating another state where the upper platen unit is lifted a distance above the cooking surface;

FIG. 7 is a fragmentary sectional view illustrating the state of FIG. 6 in which the first contact member contacts a first one of the first conductors;

FIG. 8 is a schematic side view illustrating yet another state where the upper platen unit is further lifted a distance above the cooking surface; and

FIG. 9 is a fragmentary sectional view illustrating the state of FIG. 8 in which the first contact member contacts a second one of the first conductors.

### DETAILED DESCRIPTION OF THE PREFERRED EMBODIMENT

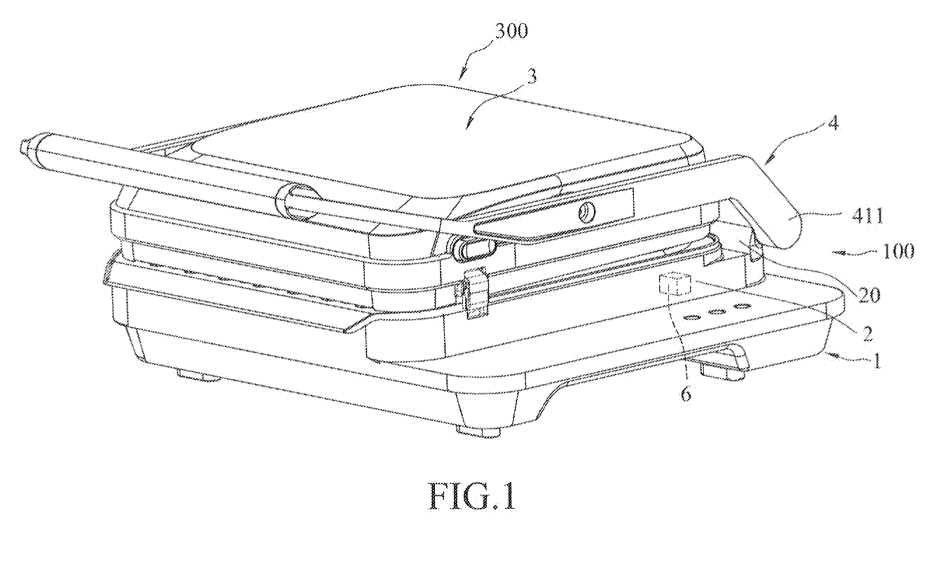

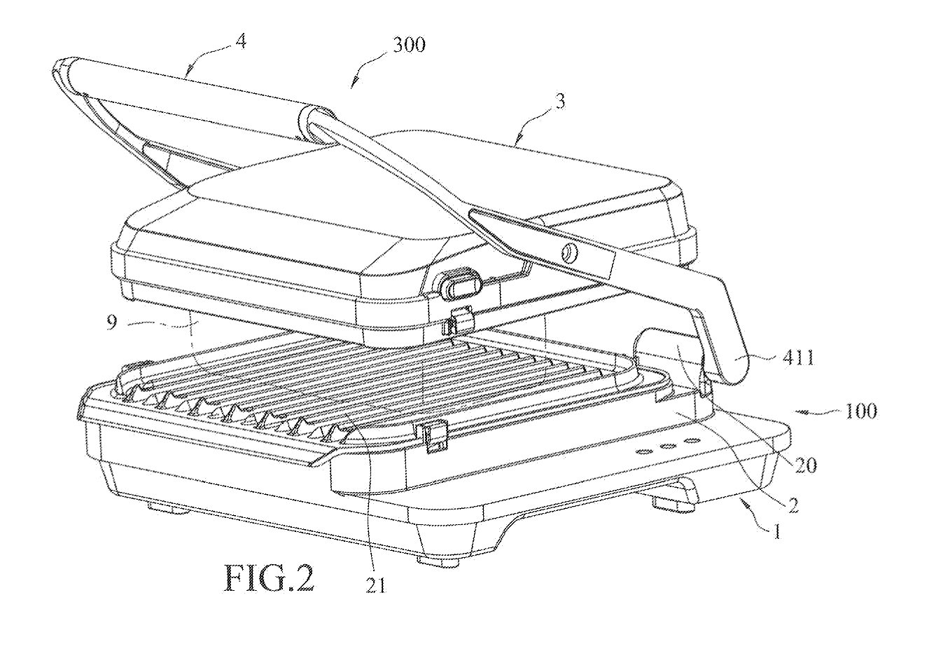

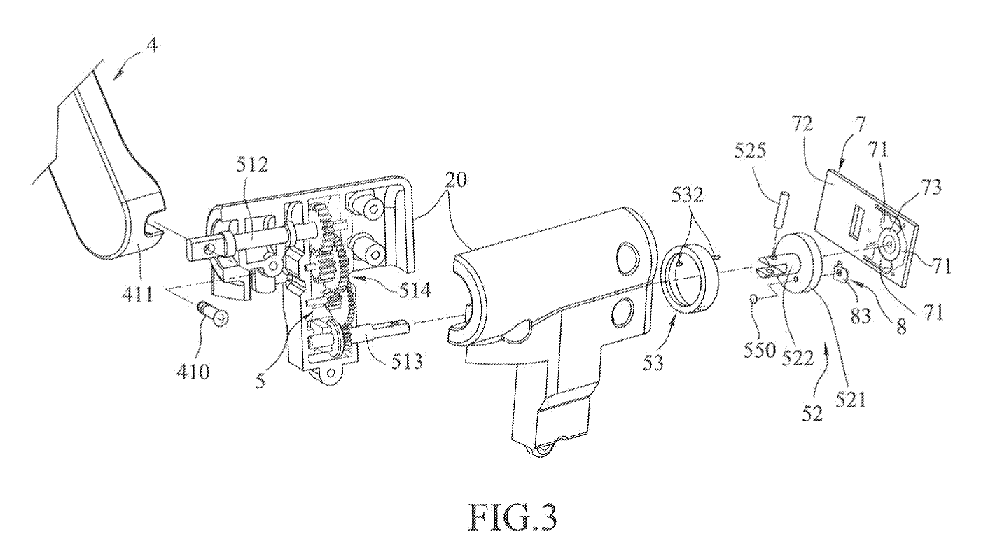

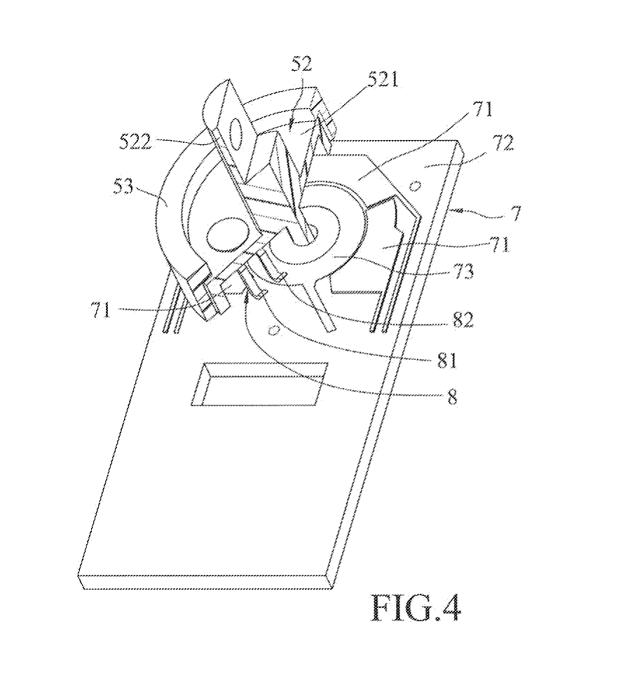

FIGS. 1 to 5 illustrate the preferred embodiment of a cooking assembly according to the present invention for cooking a food body 9. The cooking assembly includes a cooking base unit 100, an upper platen unit 300, a transmission unit 5, a heater controller 6, a contact module 7 and a movable contact unit 8.

The cooking base unit 100 includes a stand 1, a cooking plate 3 disposed securely on the stand 1, a first pivot housing 20 that is fixed to one side of the cooking plate 2, and a second pivot housing (not shown) that is fixed to an opposite side of the cooking plate 2 and that has a structure similar to that of the first pivot housing 20. The cooking plate 2 has a cooking surface 21 that is adapted to be heated by a heater (not shown) for cooking the food body 9 placed on the cooking surface 21.

The upper platen unit 300 is pivoted to the cooking base unit 100, and includes a plate member 3 and a generally U-shaped handle 4 that is pivoted to the plate member 3 and that has two opposite ends 411 (only one is shown) which are respectively pivoted to the first pivot housing and the second pivot housing.

The transmission unit 5 includes a first rotatable shaft 513 which defines a first rotation axis, a second rotatable shaft 512 which is parallel to the first rotatable shaft 513, a rotatable contact seat 52 which is connected to the first rotatable shaft 513 so as to be co-rotatable with the first rotatable shaft 513 about the rotation axis, and a gear set 514 which couples the first rotatable shaft 513 to the second rotatable shaft 512. The rotatable contact seat 52 is connected to and driven by the upper platen unit 300 through the first and second rotatable shafts 513, 512 and the gear set 514 to rotate relative to the contact module 7.

The heater controller 6 is connected to the cooking base unit 100, is adapted to be connected to the heater, and is configured to generate output signals corresponding respectively to different predetermined cooking modes for controlling the heater. Each predetermined cooking mode controls the heater to cook the food body 9 with a corresponding thickness.

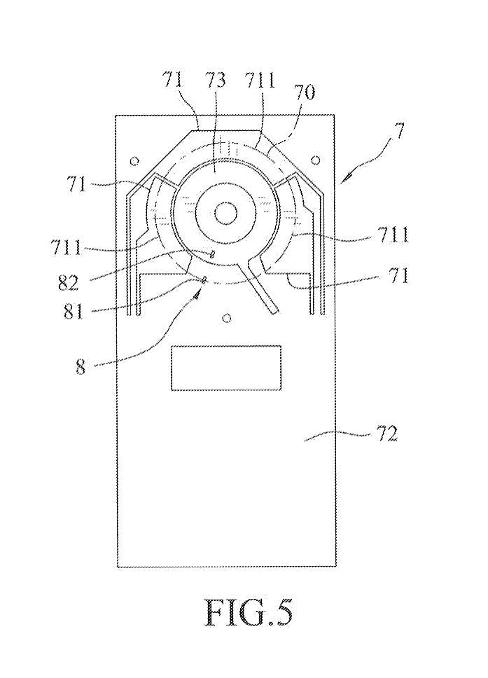

The contact module 7 is secured to the cooking base unit 100 by mounting securely in the first pivot housing 20, and includes an insulator seat 72, a central conductor 73 that is attached to the insulator seat 72 and that is electrically connected to the heater controller 6, and a plurality of peripheral conductors 71 that are attached to the insulator seat 72, that are spaced apart from the central conductor 73, and that are electrically connected to the heater controller 6. The central conductor 73 is generally annular in shape. The peripheral conductors 71 are angularly displaced from one another around the central conductor 73, and define contact regions 711 (see FIG. 5) for contacting the movable contact unit 8. The contact regions 711 are disposed along a circular contact path 70 and are operatively associated with the heater controller 6 for the generation of the output signals.

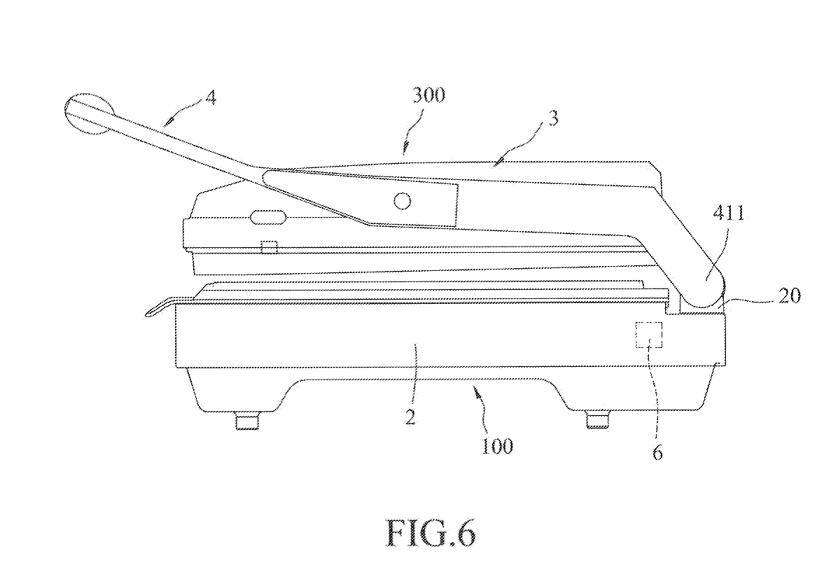

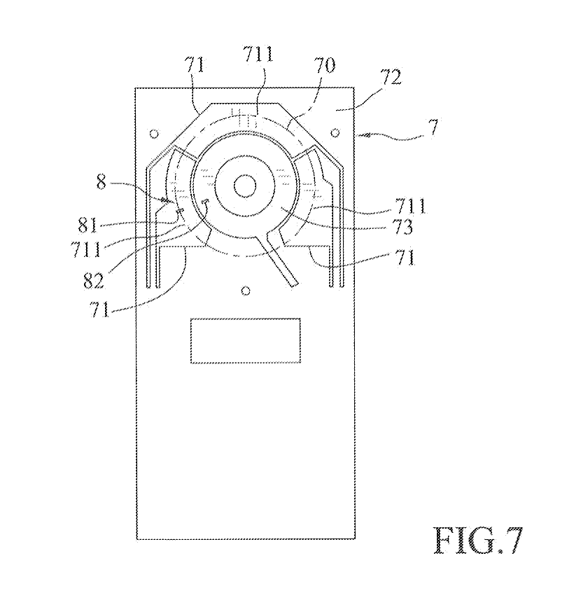

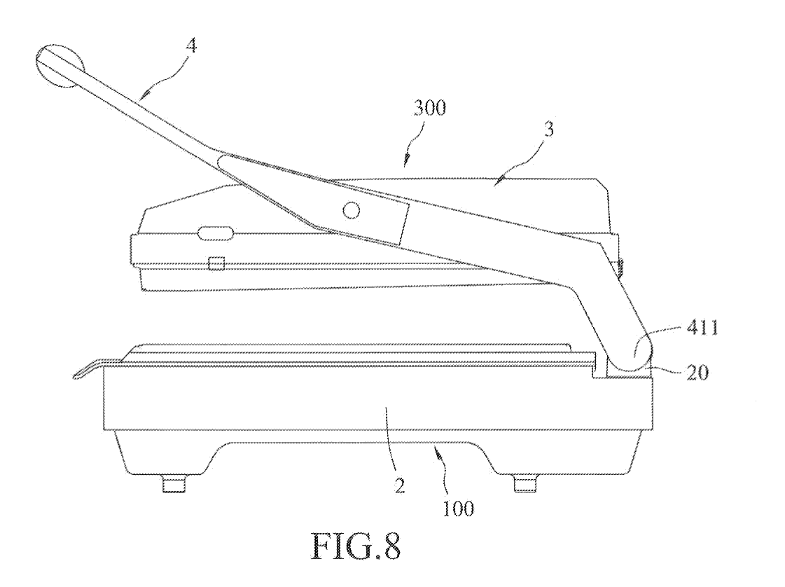

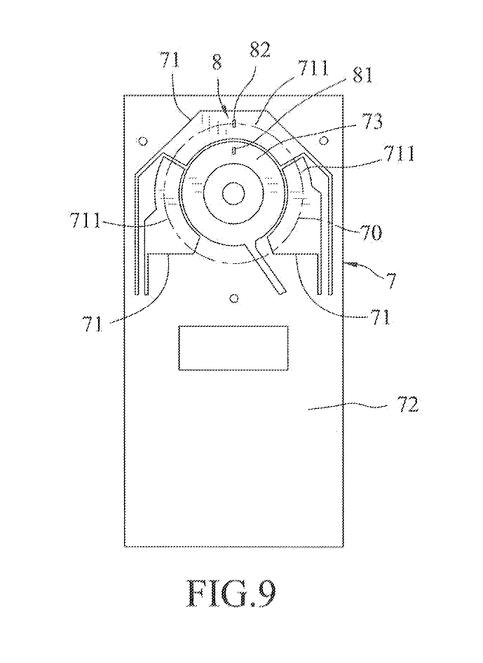

The movable contact unit 8 is a single piece of a metal, and includes a conductive first contact member 81, a conductive second contact member 82 and a conductive bridging plate 83. The first and second contact members 81, 82 are bridged by and protrude from the bridging plate 83. The bridging plate 83 is fixed to the rotatable contact seat 52 through a rivet 550, so that the first contact member 81 may be connected to and driven by the upper platen unit 300 through the transmission unit 5 to move along the contact path 70 when the upper platen unit 300 rotates relative to the cooking base unit 100 so as to contact a selected one of the contact regions 711 (see FIGS. 6 to 9) to enable the heater controller 6 to generate a corresponding one of the output signals. The second contact member 82 constantly contacts the central conductor 73 when the first contact member 81 is moved along the contact path 70 to contact any selected one of the contact regions 711, thereby establishing an electrical connection between the central conductor 73 and the selected one of the peripheral conductors 71, which results in the generation of the output signal by the heater controller 6. Alternatively, the enablement of the heater controller 6 to generate the output signal may be carried out by a different circuit design. For instance, the first contact member 81 may be in contact with a resistor, such that movement of the first contact member 81 on the resistor results in a change in an overall resistance of the circuit, which may be used as a signal for the heater controller 6 to control the heater.

The movable contact unit 8 and the transmission unit 5 are mounted in the first pivot housing 20.

The rotatable contact seat 52 has a circular plate 521 and a rod 522 that extends coaxially from the circular plate 521. The first rotatable shaft 513 is coaxially connected to the rod 522 through a lock pin 525. The transmission unit 5 further includes a sleeve 53 that is fixed to the contact module 7 through mounting pins 532 and that is sleeved around and that is disposed adjacent to the circular plate 521 so as to maintain the rotatable contact seat 52 to be substantially and coaxially disposed about the rotation axis of the first rotatable shaft 513 when the rotatable contact seat 52 is driven by the upper platen unit 300 to rotate.

One of the ends 411 of the handle 4 is securely connected to the second rotatable shaft 512 through a screw 410 so that the handle 4 may be rotatable about an axis of the second rotatable shaft 512 to simultaneously lift the upper platen unit 300 away from the cooking base unit 100 and drive rotation of the rotatable contact seat 52 and the movable contact unit 8.

By coupling the first contact member 81 to the upper platen unit 300 of the cooking assembly of the present invention, the first contact member Si would move to different positions due to different thicknesses of the food body 9 to be cooked on the cooking surface 21 of the cooking base unit 100, which leads the heater controller 6 generating an output signal corresponding to the thickness of the food body 9, thereby facilitating the proper cooking operation.

While the present invention has been described in connection with what is considered the most practical and preferred embodiment, it is understood that this invention is not limited to the disclosed embodiment but is intended to plate member unit various arrangements included within the spirit and scope of the broadest interpretation, and equivalent arrangements.

What is claimed is:

1. A cooking assembly comprising:
a cooking base unit having a cooking surface that is adapted to he heated by a heater;
an upper platen unit pivoted to said cooking base unit;
a heater controller connected to said cooking base unit, adapted to be connected to said heater, and configured to generate output signals corresponding respectively to different cooking modes for controlling the heater;
a contact module secured to said cooking base unit and defining a plurality of conductive contact regions that are electrically connected to said heater controller and that are operatively associated with said heater controller for the generation of said output signals, said contact regions being disposed along a contact path; and
a conductive first contact member connected to and driven by said upper platen unit to move along the contact path when said upper platen unit rotates relative to said cooking base unit so as to contact a selected one of said contact regions to enable said heater controller to generate a corresponding one of the output signals.

2. The cooking assembly of claim 1, further comprising a rotatable contact seat, a conductive bridging plate and a second contact member, said rotatable contact seat being connected to and driven, by said upper platen unit to rotate relative to said contact module, said contact module including an insulator seat, a central conductor that is attached to said insulator seat and that is electrically connected to said heater controller, and a plurality of peripheral conductors that are attached to said insulator seat, that are spaced apart from said central conductor, and that are electrically connected to said heater controller, said bridging plate being fixed to said rotatable contact seat, said first and second contact members being bridged by and protruding from said bridging plate, said peripheral conductors defining said conductive regions, respectively, said second contact member contacting said central conductor when said first contact member is moved along the contact path to contact any one of said contact regions.

3. The cooking assembly of claim 2, wherein said central conductor is annular in shape, said peripheral conductors being angularly displaced from one another around said central conductor.

4. The cooking assembly of claim 1, further comprising a transmission unit that couples said upper platen unit to said first contact member and that includes a first rotatable shaft which defines a rotation axis, and a rotatable contact seat which is connected to said first rotatable shaft so as to be co-rotatable with said first rotatable shaft about the rotation axis, said contact module being fixed to said cooking base unit, said first contact member being fixed to said rotatable contact seat.

5. The cooking assembly of claim 4, wherein said rotatable contact seat has a circular plate and a rod that extends coaxially from said circular plate, said first rotatable shaft being coaxially connected to said rod, said transmission unit further including a sleeve that is fixed to said contact module and that is sleeved around and that is disposed adjacent to said circular plate so as to maintain, said rotatable contact seat to be substantially disposed about the rotation axis when said rotatable contact seat is driven by said upper platen unit to rotate.

6. The cooking assembly of claim 4, wherein said transmission unit further includes a second rotatable shaft and a gear set that couples said first rotatable shaft to said second rotatable shaft, said second rotatable shaft being connected to said upper platen unit.

7. The cooking assembly of claim 6, wherein said cooking base unit includes a cooking plate and a pivot housing that is fixed to said cooking plate, said upper platen unit including a plate member and a handle that is pivoted to said plate member and that is securely connected to said second rotatable shaft so as to be rotatable about an axis of said second rotatable shaft, said transmission unit and said contact module being mounted in said pivot housing.
